(19) United States
(12) Patent Application Publication
(10) Pub. No.: US 2014/0338393 A1
(43) Pub. Date: Nov. 20, 2014

(54) METHODS FOR BLENDING LIQUEFIED NATURAL GAS

(71) Applicants: Rustam H. Sethna, Clinton, NJ (US); Bryan Luftglass, West Orange, NJ (US)

(72) Inventors: Rustam H. Sethna, Clinton, NJ (US); Bryan Luftglass, West Orange, NJ (US)

(21) Appl. No.: 14/273,922

(22) Filed: May 9, 2014

Related U.S. Application Data
(60) Provisional application No. 61/822,566, filed on May 13, 2013.

(51) Int. Cl. F25J 1/00; F17C 5/02

(52) U.S. Cl. CPC F25J 1/0022; F17C 5/02
USPC 62/600; 62/49.1; 62/45.1

(57) ABSTRACT

A method for producing a blended mixture of liquefied natural gases to meet the particular requirements of an operator at a production facility, application site or a fueling station by blending together a lean liquefied natural gas and a rich liquefied natural gas. The operator can control through a device such as a heat exchange blending system the composition of the end product mixed liquefied natural gas for its intended end use.

### CROSS REFERENCE TO RELATED APPLICATIONS

This application claims priority from U.S. Provisional Patent Application Ser. No. 61/822,566 filed May 13, 2013.

### BACKGROUND OF THE INVENTION

Differing market quality specifications challenge liquefied natural gas (LNG) producers especially because of the growth in shale gas production and the growing opportunity for liquefied natural gas fuels having varied calorific values. This is particularly acute in the United States and Canada, but may become no less important in other geographies, which has created a need for production to address new quality issues.

The current and emerging United States liquefied natural gas market provides an opportunity to offer a wide range of “tailored” liquefied natural gas qualities characterized primarily by their heating value or ethane and higher hydrocarbons content. The need for this flexibility is on the increase because of the rapid growth of the liquefied natural gas spot market, the increase in heavier hydrocarbon and ethane content from fraccing sources, little and varied regulation of ethane content in interstate and intrastate natural gas pipelines, stricter engine specifications for ethane (e.g., <4% for Westport engines and <6% CARB specification) and higher hydrocarbons (e.g., <3% C3+ CARB specification), and limited hydrocarbon recovery infrastructure relative to the growing liquefied natural gas market in many areas.

A rich hydrocarbon byproduct stream is often produced in the coldbox column of natural gas processing and liquefaction plants. This stream can include butane, ethane and propane. These natural gas liquids (NGLs) can be shipped to market or used in refineries and petrochemical plants for fuel or feedstock. Yet, hydrocarbons having two or greater carbon atoms (C2+) that are produced as a by-product in many liquefied natural gas plants can have a limited market in certain geographies, and may need to be transported off-site for further processing or utilized on-site for other applications such as power generation. The imbalance between C2+ production and demand creates an opportunity to blend lean liquefied natural gas streams with “richer” by-product streams. This technique can be performed anywhere in the supply chain including at a production site, a fleet fueling site or an off-road application site. By blending two known streams to produce products of different specifications, a more attractive and flexible commercial option is achieved. Furthermore, a tailored product may be produced directly in the liquefied natural gas production plant by novel design and operation of the cleanup system and/or liquefier.

One way to make multiple products is to utilize a side stream from the de-methanizer/de-ethanizer column, which is typically included in many liquefied natural gas plant coldbox designs. The side-stream will be C2+-rich and can meet a fixed off-road application specification and produce a fixed, constant flow of the same, regardless of C2-rich product demand. This is a common albeit restrictive solution for the current market needs. The problem is that the C2-rich specs for each application are not fixed and the demand is variable. So, blending two known streams to produce products of different specs is an attractive, commercially more flexible option. Also, blending allows one to use products from different plants/locations and can be done at different points in the supply chain. Additionally, as the industry moves to implement new liquefied natural gas quality specifications relating to hydrocarbons, blending can play a role in managing hydrocarbon levels, while still maintaining the flexibility to accept raw natural gas streams with varying hydrocarbon levels.

### SUMMARY OF THE INVENTION

In order to address the desire to have a greater variety of liquefied natural gas blends, the present invention provides methods for blending or producing liquefied hydrocarbon streams selected from the group consisting of methane, ethane, propane, butane, liquefied petroleum gas, rich liquefied natural gas and lean liquefied natural gas. For purposes of the present invention “rich” and “lean” refer to the relative content of hydrocarbons containing one versus two or more carbon atoms.

In one embodiment, there is disclosed a method for producing a blended liquefied natural gas composition comprising mixing a lean liquefied natural gas and a rich liquefied natural gas in a liquefied natural gas supply chain.

In another embodiment of the invention there is disclosed a method for producing a fuel having a pre-determined Wobbe Index comprising a blended liquefied natural gas composition comprising mixing a lean liquefied natural gas and a rich liquefied natural gas.

The blended liquefied natural gas composition is produced at a point of use, at a production site or at an intermediate point in a liquefied natural gas supply chain.

The liquefied natural gas supply chain is selected from the group consisting of a production facility, a fuel blending facility, an application site and a fueling station.

The lean liquefied natural gas has a greater amount of hydrocarbons containing one carbon atom than hydrocarbons having two or more carbon atoms.

The rich liquefied natural gas has a greater amount of hydrocarbons containing two or more carbon atoms than hydrocarbons having one carbon atom.

The hydrocarbon containing two or more carbon atoms are selected from the group consisting of ethane, propane, butane and liquefied petroleum gas.

The blended liquefied natural gas composition is used as a fuel in internal combustion engines.

The lean liquefied natural gas and a rich liquefied natural gas are blended to achieve a required Wobbe Index for a fuel.

The lean liquefied natural gas and the rich liquefied natural gas are blended using mass flow meters and temperature and pressure control into a storage container.

The storage container can be mounted on a transportation trailer. The lean liquefied natural gas and the rich liquefied natural gas can be in two separate storage containers.

The lean liquefied natural gas and the rich liquefied natural gas are produced by a liquefied natural gas production plant.

The lean liquefied natural gas and the rich liquefied natural gas are blended in a heat exchange blending system.

The lean liquefied natural gas and the rich liquefied natural gas are contained in storage containers mounted on transportation trailers.

The lean liquefied natural gas and the rich liquefied natural gas are blended and fed to storage tanks.

Liquefied natural gas for the transportation market; i.e., diesel substitution, is typically “lean” (high methane concentrations) with strict limitations on C2+ components. But, off-road applications, such as gensets for drilling, as well as dual-fuel engines for heavy duty trucking can utilize richer product with higher C2+ and Wobbe Indices. In some/many locations, off-road demand for liquefied natural gas exceeds transportation demand.

Blending of lower heating value “lean” liquefied natural gas with higher value “rich” liquefied natural gas will improve and maintain the quality of the lower specification (i.e. “lean”) product. The improved and managed quality is ensured in the final product by meeting a target Wobbe Index and composition specification range in an economical and efficient manner.

The Wobbe Index is an indicator of the interchangeability of fuel gas such as natural gas, liquefied petroleum gas and town gas and is frequently defined in the specifications of gas supply and transport utilities.

If V_{C} is the higher heating value, or higher calorific value, and G_{S} is the specific gravity, the Wobbe Index, I_{W}, is defined as:

$${I}_{W} = \frac{{V}_{C}}{\sqrt{{G}_{S}}} .$$

Basically, the Wobbe number, or Wobbe Index, of a fuel gas is found by dividing the high heating value of the gas in Btu per standard cubic foot by the square root of its specific gravity with respect to air. The Wobbe Index is used to compare the combustion energy output of different composition fuel gases in an appliance. For appliances, the flow of gas is regulated with some type of orifice. For any given orifice, all gas mixtures that have the same Wobbe number will produce the same amount of heat, but flame temperatures and trace emissions may vary. Hence, the component hydrocarbon content is an important factor for fuel specifications.

Wobbe numbers for mixtures containing ethane can be well above 1400 BTU/scf, which often are beyond the ratings of some gas-operated equipment. Therefore, one must make sure the liquefied natural gas-derived gas is mixed with other sources in order to reduce the Wobbe Index. Alternatively, expensive processing may need to be introduced to make an adjustment.

The methods of the invention will optimally use the C2+ rich byproducts that typically result with several natural gas sources from oil and gas fields and pipelines with a substantial “heavier” fraction. The improved utilization of the C2+ fraction of the raw natural gas being processed provides for greater economic value.

The methods of the invention provide for effective control of the Wobbe Index to produce a more consistent fuel quality, or specifications for engines and turbines for a variety of applications which could result in additional benefits such as the improved lubricity of fuel for engines.

The methods of the invention further decrease the losses of liquefied natural gas in the supply chain and in fueling stations by increasing the C2+ content to lower storage and dispensing losses. These methods further limit weathering effects by controlling the hydrocarbon composition.

The improved quality of the final product will lower liquefied natural gas losses in the supply chain while providing better lubricity of engines and optimizing the Wobbe Index/HV (heating value) to meet engine temperature and emissions requirements such as nitrogen oxides and other limitations.

The blending of hydrocarbons into lean liquefied natural gas is required for high-natural gas substitution rate truck engines and off-road power generation applications common for drilling and fraccing, and mining, marine, locomotive, and stationary combustion operations. The amount of rich liquefied natural gas that is blended depends upon the type of application and the basic idea is to adjust the temperature and the pressure of each component in a manner to ensure that a sub-cooled or saturated liquid results without any potential freezing issues. The blending method takes into account the phase diagram of each component to ensure that the final stream is a sub-cooled or saturated mixture and circumvents venting or freezing.

While there are a large number of existing natural gas appliances and equipment, many are not tolerant to quality changes and are expensive to adjust in order to accommodate changing natural gas quality. So for example, gas turbine manufacturers provide guarantees which are tied to the use of a consistent quality fuel which previous methods may not have been able to generate but can be provided by the methods of the invention.

In the operation of the invention, two or more hydrocarbon streams are metered using precise flow meters, for example, Coriolis mass flow meters, along with careful control of the temperature and the pressure into a suitable storage container or into two storage tanks supporting end users. Conventional gas chromatographs are generally not responsive enough for the dynamic blending of purposes and limit the accuracy of the final blended product. Instead feed forward, and/or feed back control is used based on the flow measurements. The composition of each stream is continually monitored and kept constant in the production plant using suitable analytical devices. This metering can be accomplished with or without a heat exchange device such as a sub-cooler/saturator connected to a storage tank, or preferably directly to a fuel transport trailer with feedback or feed forward control. The dynamic blending can also be performed at the point of use, at a production site or at an intermediate point in the supply chain.

### BRIEF DESCRIPTION OF THE DRAWINGS

FIG. 1 is a schematic representation of the base case production at a liquefied natural gas production facility.

FIG. 2 is a chart describing minimum acceptable fuel specifications (CARB) for liquefied natural gas for transportation and target product specifications achieved by the invention.

FIG. 3 is a schematic representation of the mixing procedure of the invention at a liquefied natural gas production facility.

FIG. 4 is a schematic representation of the mixing procedure of the invention at an application site.

FIG. 5 is a schematic representation of the mixing procedure of the invention at a fueling station.

### DETAILED DESCRIPTION OF THE INVENTION

An in-line liquefied natural gas blender for the cryogenic blending of “rich” liquefied natural gas/byproduct and “lean” liquefied natural gas or C2-rich liquid hydrocarbon stream can be utilized to achieve quality improvement and cost reduction. Blend qualities can be dynamically optimized to meet BTU and hydrocarbon specifications for a variety of applications.

The method describes optimally utilizing the C2+ rich byproducts that will typically result with several natural gas sources from pipelines with a substantial “heavier” fraction. For instance, greater economic production value is achieved by improved utilization of the C2+ fraction of the raw natural gas being processed. The method also provides for effectively controlling the Wobbe Index to produce a more consistent fuel quality, or specifications for engines and turbines for multiple applications simultaneously, which could result in additional benefits such as improved lubricity of fuel for engines. The method also shows one can decrease the losses of liquefied natural gas in supply chain and in fuelling stations and any storage vessels by increasing the C2+ content to lower all storage losses and how to limit weathering effects by proper control of hydrocarbons and maintaining a minimum usage rate.

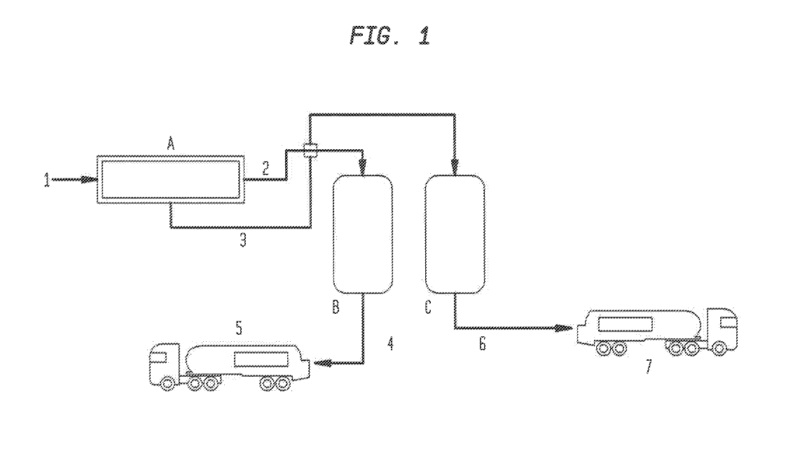

FIG. 1 is a schematic of base case production at a liquefied natural gas production facility. Raw natural gas is fed into a liquefied natural gas production plant which will produce a rich liquefied natural gas and a lean liquefied natural gas. Both of these production streams are fed to storage tanks where they will store their respective streams until they are distributed. The lean liquefied natural gas being fed to a trailer as fuel for a transportation customer and the rich liquefied natural gas is fed to a trailer fill or a supply line for liquefied petroleum gas blending, power generation or processing plant.

In FIG. 1, raw natural gas is fed through line 1 to a liquefied natural gas production plant A. The liquefied natural gas production plant will produce a first stream of lean liquefied natural gas which will be fed through line 3 to a lean natural gas storage tank C. The lean natural gas storage tank can be made of any materials that are typically employed to store liquefied natural gas. The lean natural gas can be used as a fuel and is fed through line 6 to a trailer 7 for transportation to a customer.

A rich by-product is also produced by the liquefied natural gas production plant. This rich by-product is fed through line 2 to a rich by-product storage tank B. The rich by-product is fed through line 4 to a trailer 5 for liquefied petroleum gas blending, power generation or a processing plant.

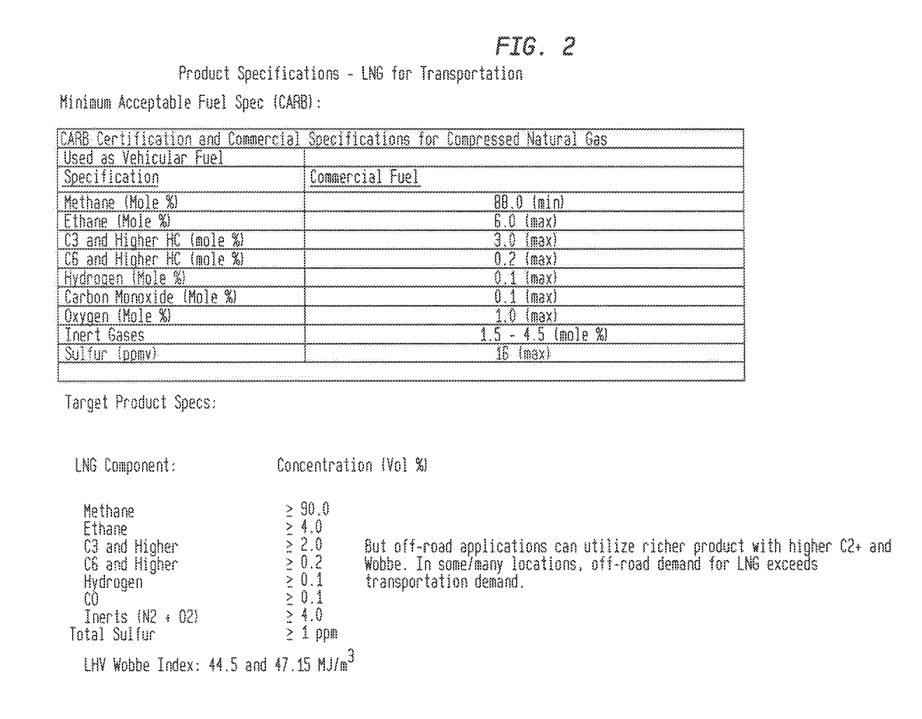

FIG. 2 is a chart showing the minimum acceptable fuel specifications (CARB) for liquefied natural gas for transportation purposes. Below these specifications are target product specifications that are achieved using the methods of the present invention. As noted in the target product specifications, greater levels of methane are achieved while lower levels of other components are also obtained.

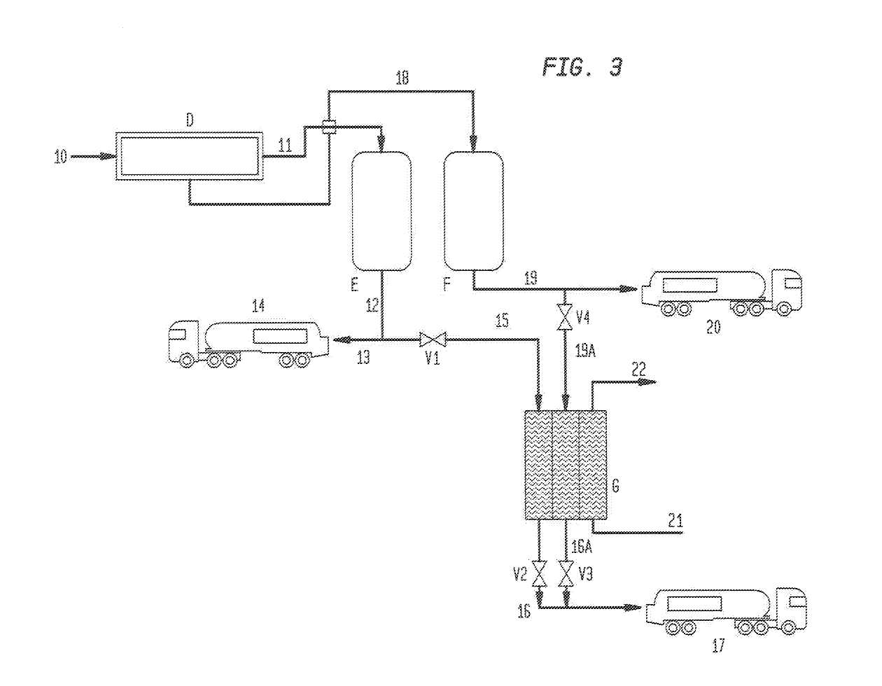

FIG. 3 is a schematic of the operation of the invention at a production facility. Raw natural gas is fed to a liquefied natural gas production plant which will produce two product streams. The first stream is a rich by-product liquefied natural gas and the second is a lean liquefied natural gas. Both of these streams are fed to separate storage containers.

The raw natural gas feed is fed through line 10 to a liquefied natural gas plant D. The liquefied natural gas production plant will produce a first stream of lean liquefied natural gas which will be fed through line 18 to a lean natural gas storage tank F. The lean natural gas storage tank can be made of any materials that are typically employed to store liquefied natural gas. The lean natural gas can be used as a fuel and is fed through line 19 to a trailer 20 for transportation to a customer.

A rich by-product is also produced by the liquefied natural gas production plant D. This rich by-product is fed through line 11 to a rich by-product storage tank E. The rich by-product is fed through lines 12 and 13 to a trailer 14 for liquefied petroleum gas blending, power generation or a processing plant.

A valve V1 will control the flow of the rich by-product and when this valve is open, the rich by-product can flow through valve V1 and line 15 to a heat exchange blending system G. The heat exchange blending system has a programmable logic control (PLC) that can control the flow, temperature, pressure and composition of the mixture in the heat exchange blending system G.

Valve V4 connects to line 19 and when open diverts a portion of the lean liquefied natural gas flowing through line 19 to line 19A where it will enter the heat exchange blending system G. The lean liquefied natural gas can then be blended with the rich by-product to produce a unique blend of liquefied natural gas for an off-road customer. Accordingly, valves V2 or V3 can be opened and the blended liquefied natural gas can be fed from the heat exchange blending system G through line 16 to a trailer 17 for delivering the blending liquefied natural gas to an off-road customer. The heat exchange blending system can operate to produce the mixture in real time to meet BTU specification for the customer/operator or be programmed to produce a predetermined mixture.

The heat exchange blending system optionally has a refrigeration loop 21 and 22 attached to it whereby liquid nitrogen for example is passed through the heat exchange blending system G to provide cooling to the mixtures of the liquefied natural gas.

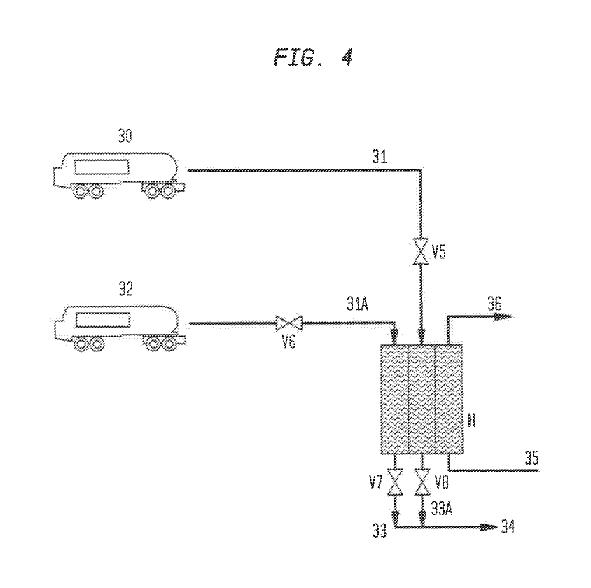

FIG. 4 is a schematic of the operation of the invention at a blending or application site such as for blending liquefied natural gas for use by a customer off road or in dual-fuel on-road vehicles. A transportation trailer or other mobile storage device will feed a stream of lean liquefied natural gas to the heat exchange blending system. As described above with respect to FIG. 3, the heat exchange blending system is a device that allows for the control of flow, temperature, pressure and composition of a blended stream.

In FIG. 4, the portable storage container 30 can be a trailer vessel designed for transportation from a production facility to for example a customer site. There the lean liquefied natural gas is fed through line 31 and open valve V4 to a heat exchange blending system H.

Likewise a portable storage container 32 can feed rich liquefied natural gas through open valve V6 and line 31A to the heat exchange blending system H.

The heat exchange blending system has a programmable logic control (PLC) that can control the flow, temperature, pressure and composition of the mixture in the heat exchange blending system H.

The lean liquefied natural gas and rich liquefied natural gas can be blended together to produce a mixture in real time to meet the BTU specification for the customer/operator or be programmed to produce a predetermined mixture. Valves V7 and V8 can be opened and the mixed liquefied natural gas can be fed through line 33 and 33A to line 34 which is directed to a transport trailer or storage tank which an off-road customer can pump or vaporize for fueling purposes at the customer's facility.

The heat exchange blending system optionally has a refrigeration loop 35 and 36 attached to it whereby liquid nitrogen for example is passed through the heat exchange blending system to provide cooling to the mixtures of the liquefied natural gas.

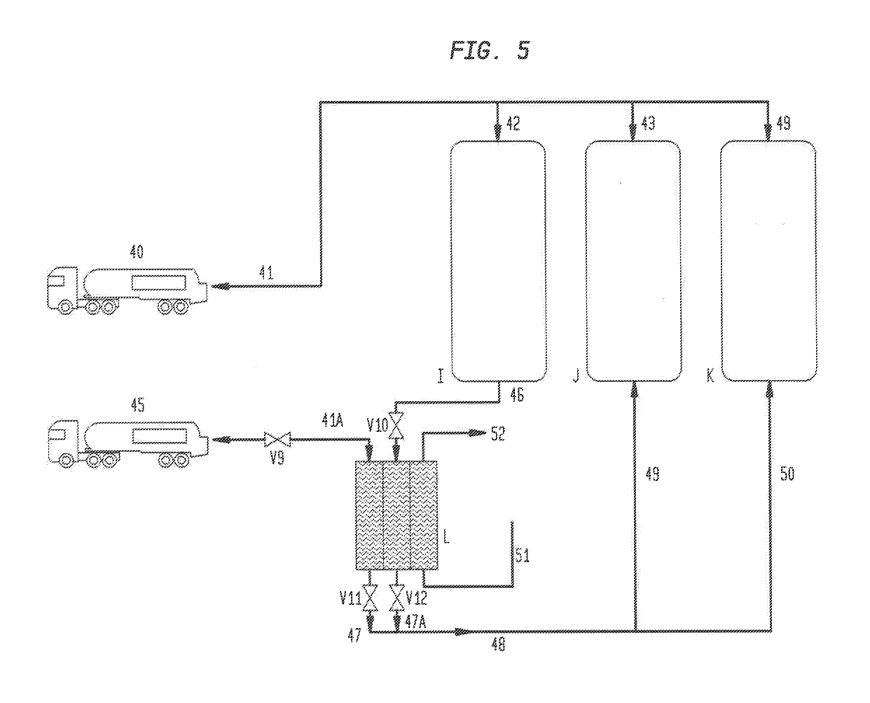

FIG. 5 is a schematic of the operation of the invention at a blending or fueling station. A transportation trailer or other mobile storage device containing lean liquefied natural gas feeds the lean liquefied natural gas to a series of three storage tanks. The first storage tank will feed the lean liquefied natural gas from its bottom to a heat exchange blending system. The heat exchange blending system optionally has a refrigeration loop attached to it whereby liquid nitrogen for example is passed through the heat exchange blending system to provide cooling to the mixtures of the liquefied natural gas.

In FIG. 5, the situation represents providing blends to a fueling station. The portable storage container can be a trailer or other mobile delivery device 40 which can store and provide lean liquefied natural gas to station storage tanks. In this instance, the lean liquefied natural gas is fed through line 41 where it can enter station storage tanks I, J and K through line 42, 43 and 44 respectively.

A portable storage container such as a trailer or other mobile delivery device 45 will deliver rich liquefied natural gas through open valve V9 and line 41A to the heat exchange blending system L. The lean liquefied natural gas in station storage tank I can be fed through line 46 when valve V10 is open to the heat exchange blending system L. The lean liquefied natural gas and the rich liquefied natural gas can be blended together produce a mixture in real time to meet the BTU specification for the customer/operator or be programmed to produce a predetermined mixture.

The blended liquefied natural gas mixture can be fed through lines 47 and 47A through open valves V11 and V12 respectively to line 48. In this instance the fueling station operator will have chosen to keep storage tanks J and/or K empty of lean liquefied natural gas from storage trailer 40. As such, the blended liquefied natural gas mixture from the heat exchange blending system L will be fed through line 48 to either line 49 or line 50 or both to deliver to station storage tanks J and/or K the blended liquefied natural gas mixture for storage and later use in fueling operations at the fueling station. Based on the particular needs of the customer/operator the second and the third storage tanks could have the same blend of lean and rich liquefied natural gases or they may have different blend compositions.

The heat exchange blending system optionally has a refrigeration loop 51 and 52 attached to it whereby liquid nitrogen for example is passed through the heat exchange blending system to provide cooling to the mixtures of the liquefied natural gas.

In this embodiment of the invention, the first storage tank acts as an intermediary tank whereby the lean liquefied natural gas is temporarily stored before being fed in to the heat exchange blending system. While the lean liquefied natural gas can be fed to the second and third storage tanks, they are primarily used to store the blended liquefied natural gas that is produced in the heat exchange blending system.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A method for producing a blended liquefied natural gas composition comprising mixing a lean liquefied natural gas and a rich liquefied natural gas in a liquefied natural gas supply chain.

2. The method as claimed in claim 1 wherein the blended liquefied natural gas composition is produced at a point of use, at a production site or at an intermediate point in a liquefied natural gas supply chain.

3. The method as claimed in claim 1 wherein the liquefied natural gas supply chain is selected from the group consisting of a production facility, a fuel blending facility, an application site and a fueling station.

4. The method as claimed in claim 1 wherein the lean liquefied natural gas has a greater amount of hydrocarbons containing one carbon atom than hydrocarbons having two or more carbon atoms.

5. The method as claimed in claim 1 wherein the rich liquefied natural gas has a greater amount of hydrocarbons containing two or more carbon atoms than hydrocarbons having one carbon atom.

6. The method as claimed in claim 1 wherein the hydrocarbon containing two or more carbon atoms are selected from the group consisting of ethane, propane, butane and liquefied petroleum gas.

7. The method as claimed in claim 1 wherein the blended liquefied natural gas composition is used as a fuel in internal combustion engines.

8. The method as claimed in claim 1 wherein the lean liquefied natural gas and a rich liquefied natural gas are blended to achieve a required Wobbe Index for a fuel.

9. The method as claimed in claim 1 wherein the lean liquefied natural gas and the rich liquefied natural gas are blended using mass flow meters and temperature and pressure control into a storage container.

10. The method as claimed in claim 9 wherein the storage container is mounted on a transportation trailer.

11. The method as claimed in claim 10 wherein the lean liquefied natural gas and the rich liquefied natural gas are in two separate storage containers.

12. The method as claimed in 1 wherein the lean liquefied natural gas and the rich liquefied natural gas are produced by a liquefied natural gas production plant.

13. The method as claimed in claim 1 wherein the lean liquefied natural gas and the rich liquefied natural gas are blended in a heat exchange blending system.

14. The method as claimed in claim 1 wherein lean liquefied natural gas and the rich liquefied natural gas are contained in storage containers mounted on transportation trailers.

15. The method as claimed in claim 1 wherein the lean liquefied natural gas and the rich liquefied natural gas are blended and fed to storage tanks.

16. A method for producing a fuel having a pre-determined Wobbe Index comprising a blended liquefied natural gas composition comprising mixing a lean liquefied natural gas and a rich liquefied natural gas.

17. The method as claimed in claim 16 wherein the blended liquefied natural gas composition is produced at a point of use, at a production site or at an intermediate point in a liquefied natural gas supply chain.

18. The method as claimed in claim 16 wherein the liquefied natural gas supply chain is selected from the group consisting of a production facility, a fuel blending facility, an application site and a fueling station.

19. The method as claimed in claim 16 wherein the lean liquefied natural gas has a greater amount of hydrocarbons containing one carbon atom than hydrocarbons having two or more carbon atoms.

20. The method as claimed in claim 16 wherein the rich liquefied natural gas has a greater amount of hydrocarbons containing two or more carbon atoms than hydrocarbons having one carbon atom.

21. The method as claimed in claim 16 wherein the hydrocarbon containing two or more carbon atoms are selected from the group consisting of ethane, propane, butane and liquefied petroleum gas.

22. The method as claimed in claim 16 wherein the blended liquefied natural gas composition is used as a fuel in internal combustion engines.

23. The method as claimed in claim 16 wherein the lean liquefied natural gas and the rich liquefied natural gas are blended using mass flow meters and temperature and pressure control into a storage container.

24. The method as claimed in claim 23 wherein the storage container is mounted on a transportation trailer.

25. The method as claimed in claim 24 wherein the lean liquefied natural gas and the rich liquefied natural gas are in two separate storage containers.

26. The method as claimed in 16 wherein the lean liquefied natural gas and the rich liquefied natural gas are produced by a liquefied natural gas production plant.

27. The method as claimed in claim 16 wherein the lean liquefied natural gas and the rich liquefied natural gas are blended in a heat exchange blending system.

28. The method as claimed in claim 16 wherein lean liquefied natural gas and the rich liquefied natural gas are contained in storage containers mounted on transportation trailers.

29. The method as claimed in claim 16 wherein the lean liquefied natural gas and the rich liquefied natural gas are blended and fed to storage tanks.
